(19) United States
(12) Patent Application Publication
(10) Pub. No.: US 2025/0275544 A1
(43) Pub. Date: Sep. 4, 2025

(54) Poultry Shackle

(71) Applicant: Grover Harben, Gainesville, GA (US)

(72) Inventor: Grover Harben, Gainesville, GA (US)

(21) Appl. No.: 19/065,525

(22) Filed: Feb. 27, 2025

Related U.S. Application Data
(60) Provisional application No. 63/559,394, filed on Feb. 29, 2024.

(51) Int. Cl. A22B 7/00; A22B 5/00

(52) U.S. Cl. CPC A22B 7/002; A22B 5/00; A22B 7/003

(57) ABSTRACT

An articulating, rotating poultry shackle. The shackle has a central member conventionally coupled to a picking line of the processing facility, a fixed hanging portion rigidly coupled to the central member, and an articulating hanging portion rotatably coupled to the fixed hanging portion. A mounting assembly coupled to the central member rotatably attaches the central member to the picking line such that at least three degrees of rotational freedom are provided to the articulating hanging portion of the shackle.

### CROSS-REFERENCE TO RELATED APPLICATIONS

This application claims the benefit of and priority to U.S. Provisional Patent 63/559,394, filed Feb. 29, 2024, which is incorporated in its entirety in this document by reference.

### FIELD OF THE INVENTION

This invention relates to devices, systems and methods for hanging live poultry. More particularly, this invention relates to an articulating poultry shackle, a rotating poultry shackle, and an articulating, rotating poultry shackle as well as systems and methods for hanging live poultry on shackles for processing.

### BACKGROUND OF THE INVENTION

In poultry processing plants, birds are typically processed in an inverted position with their hocks suspended by shackles pivotally mounted to an overhead conveyor line. Conventionally, the shackles for hanging the bird are rigid shackles coupled to a rail and or chain picking line that move the shackles through the processing facility. That is, a conventional shackle is a rigid, fixed shackle that is not rotatable. This requires that the bird to be placed into the shackle be positioned in a particular position. However, positioning the bird in the particular position can be difficult and requires restraining the bird, orienting the bird correctly relative to the shackles of the conveyor, and placing the bird into the shackles. Therefore, there is a need in the industry for a shackle that is rotatable and/or articulable to provide more flexibility in the way birds can be placed into the shackle. The present invention fulfills these needs and provides further related advantages as describe herein.

### SUMMARY

The application relates to devices, systems and methods for hanging live poultry. More particularly, this application relates to an articulating poultry shackle, a rotating poultry shackle, and an articulating, rotating poultry shackle as well as systems and methods for hanging live poultry on shackles for processing.

In one aspect, the articulating shackle comprise a central member conventionally coupled to a picking line of the processing facility, a fixed hanging portion rigidly coupled to the central member, and an articulating hanging portion rotatably coupled to the fixed hanging portion. In another aspect, the rotating shackle can comprise the central member, the fixed hanging portion rigidly coupled to the central member and a mounting assembly coupled to the central member for rotatably attaching the central member to the picking line of the processing facility. In still another aspect, the articulating, rotating shackle can comprise the central member, the fixed hanging portion rigidly coupled to the central member, the articulating hanging portion rotatably coupled to the fixed hanging portion, and the mounting assembly coupled to the central member for rotatably attaching the central member to the picking line.

The shackle can have one, two, three or more than three rotational degrees of freedom. For example, the rotational degrees of freedom can comprise at least one of: 1) the articulated hanging portion rotating relative to the fixed hanging portion about a pivot axis, 2) the articulated hanging portion and the fixed hanging portion rotating relative to a mounting plate about a longitudinal axis; and 3) the articulated hanging portion and the fixed hanging portion rotating relative to the mounting plate about a pivot axis.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

Related methods of operation are also provided. Other apparatuses, methods, systems, features, and advantages of the poultry shackle will be or become apparent to one with skill in the art upon examination of the following figures and detailed description. It is intended that all such additional apparatuses, methods, systems, features, and advantages be included within this description, be within the scope of the poultry shackle, and be protected by the accompanying claims.

### DESCRIPTION OF THE FIGURES

FIG. 1 is a front elevational view of an articulating, rotating shackle according to one aspect, in which the shackle is in a first shackle position;

FIG. 2 is a left elevational view of the articulating, rotating shackle of FIG. 1, in which a portion of the shackle has rotated to a second shackle position;

FIG. 3 is a right elevational view of the articulating, rotating shackle of FIG. 1;

FIG. 4 right elevational view of the articulating, rotating shackle of FIG. 1, in which a portion of the shackle has rotated to a third shackle position;

FIG. 5 is a first perspective view of a mounting assembly of the articulating, rotating shackle of FIG. 1, according to one aspect;

FIG. 6 is a second perspective view of the mounting assembly of the FIG. 5; and

FIG. 7 is a third perspective view of the mounting assembly of the FIG. 5.

### DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “element” includes aspects having two or more such elements unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint and independently of the other endpoint.

As used herein, the terms “optional” or “optionally” mean that the subsequently described event or circumstance may or may not occur, and that the description includes instances where said event or circumstance occurs and instances where it does not.

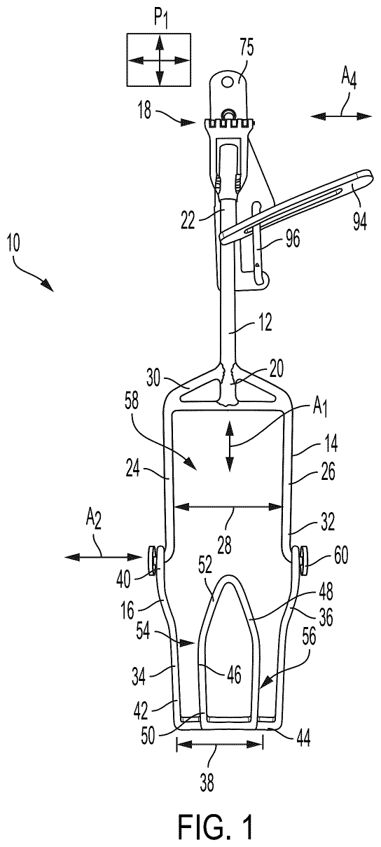

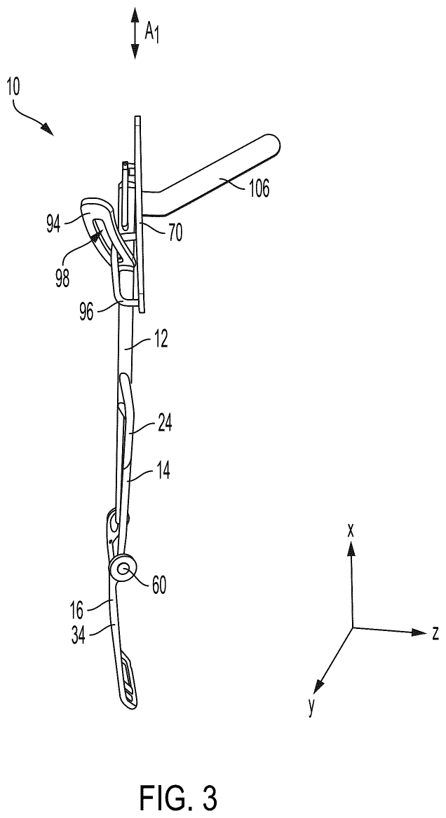

The shackle 10 is illustrated in FIGS. 1-7, according to various aspects. In one aspect, the shackle 10 can comprise a central member 12, a fixed hanging portion 14 rigidly coupled to the central member 12, and an articulating hanging portion 16 rotatably coupled to the fixed hanging portion 14. In another aspect, the shackle 10 can comprise the central member 12, the fixed hanging portion 14 rigidly coupled to the central member 12 and a mounting assembly 18 coupled to the central member 12 for rotatably attaching the central member 12 to a picking line (not shown) of the processing facility. In still another aspect, the shackle 10 can comprise the central member 12, the fixed hanging portion 14 rigidly coupled to the central member 12, the articulating hanging portion 16 rotatably coupled to the fixed hanging portion 14, and the mounting assembly 18 coupled to the central member 12 for rotatably attaching the central member 12 to a picking line (not shown) of the processing facility so that the picking line can move the shackle 10 throughout the processing facility.

The central member 12 can be an elongate member having a first end 20 and an opposed second end 22 such that the central member 12 extends along a first longitudinal axis A₁. The fixed hanging portion 14 can comprise an elongate first fixed leg 24 and an elongate second fixed leg 26 that is spaced from the first fixed leg 24 a predetermined distance 28. Each of the first fixed leg 24 and the second fixed leg 26 have a proximal end 30 fixedly attached to the first end 20 of the central member 12 and a distal end 32 extending away from the proximal end 30. In one aspect, at least a portion on the first fixed leg 24 and/or a portion of the second fixed leg 26 can be substantially parallel to the first longitudinal axis A₁.

The articulating hanging portion 16 can comprise a first rotating leg 34 and a second rotating leg 36 that is spaced from the first rotating leg 34 a predetermined distance 38. In one aspect, at least a portion on the first rotating leg 34 and/or a portion of the second rotating leg 36 can be substantially parallel to the first longitudinal axis A₁, though it is contemplated that no portion of the first rotating leg 34 and/or the second rotating leg 36 need be substantially parallel to the first longitudinal axis A₁. Each of the first rotating leg 34 and the second rotating leg 36 have a proximal end 40 and an opposed distal end 42 extending away from the proximal end 40. In another aspect, at least a portion of the first rotating leg 34 can taper towards the second rotating leg 36, and/or at least apportion of the second rotating leg 36 can taper towards the first rotating leg 34. That is, in this aspect, the distal ends 42 of the first rotating leg 34 and the second rotating leg 36 can be positioned closer together than the proximal ends 40 of the first rotating leg 34 and the second rotating leg 36.

The articulating hanging portion 16 can further comprise a connecting member 44, a first inner member 46 and a second inner member 48. The connecting member 44 can fixedly couple the distal end 42 of the first rotating leg 34 to the distal end 42 of the second rotating leg 36. In one aspect, the connecting member 44 can be substantially perpendicular to the first longitudinal axis A₁ though it is contemplated that the connecting member 44 need not be substantially perpendicular to the first longitudinal axis A₁.

Each of the first inner member 46 and the second inner member 48 have a distal end 50 fixedly attached to the connecting member 44 and a proximal end 52 extending away from the distal end 50. In one aspect, the proximal end 52 of the first inner member 46 can be fixedly attached to the proximal end 52 of the second inner member 48, though the proximal end 52 of the first inner member 46 need not be fixedly attached to the proximal end 52 of the second inner member 48. In another aspect, at least a portion of the first inner member 46 can taper away from the second inner member 48, and/or at least apportion of the second inner member 48 can away from the first inner member 46. That is, in this aspect, the proximal ends 52 of the first inner member 46 and the second inner member 48 can be positioned closer together than the distal ends 50 of the first inner member 44 and the second inner member 46.

In one aspect, the first rotating leg 34, the connecting member 44, and the first inner member 46 cooperate to form a first slot 54, and the second rotating leg 36, the connecting member 44, and the second inner member 48 cooperate to form a second slot 56. Because of the taper of the first rotating leg 34, the second rotating leg 36, the first inner member 46, and/or the second inner member 48, at least a portion of the first slot 54 and the second slot 56 can be a tapered slot having a greater slot width adjacent to the proximal ends 40 of the first rotating leg 34 and the second rotating leg 36 than the slot width adjacent to the distal ends 42 of the first rotating leg 34 and the second rotating leg 36. In still another aspect, at least a portion of the first inner member 46 can be spaced from the first rotating leg 34 a first predetermined distance, and at least a portion of the second inner member 48 can be spaced from the second rotating leg 46 a second predetermined distance so that the first slot 54 and the second slot 56 are sized to receive the legs of the bird. In this aspect, the first predetermined distance can be substantially the same as the second predetermined distance, though the first predetermined distance need not be substantially the same as the second predetermined distance.

A central cavity 58 can be defined by at least a portion of the first fixed leg 24, the second fixed leg 26, the first rotating leg 34, the second rotating leg 36 and the connecting member 44. In one aspect, the central cavity 58 can be sized and shaped to allow the legs of the bird to be inserted into the central cavity 58 before one leg of the bird is urged into the first slot 54 and the other leg of the bird is urged into the second slot 56 such that the bird is secured into the shackle 10.

As previously discussed, the shackle 10 can be an articulating shackle such that the first fixed leg 24 and the second fixed leg 26 are fixed relative to the central member 12, while the first rotating leg 34, the second rotating leg 36, the connecting member 44, the first inner member 46 and the second inner member 48 can rotate relative to the first fixed leg 24 and the second fixed leg 26. In one aspect, a first hinge or first pivot point 60 can be formed and/or positioned on the distal end 32 of the first fixed leg 24 and/or the second fixed leg 26. In this aspect, the first hinge 60 can be configured so that the first rotating leg 34, the second rotating leg 36, the connecting member 44, the first inner member 46 and the second inner member 48 can rotate about a second pivot axis A₂ relative to the first fixed leg 24 and the second fixed leg 26. The second pivot axis A₂ can be substantially perpendicular to the first longitudinal axis A₁ in which at least a portion of the central member 12 can be positioned.

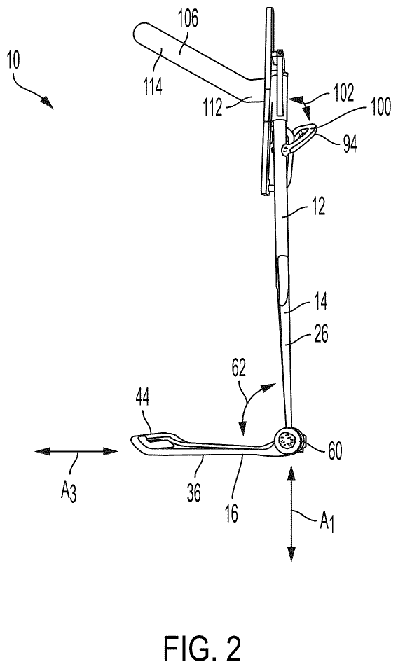

As illustrated in FIG. 2, at least a portion of the first fixed leg 24 and the second fixed leg 26 can extend along the first longitudinal axis A₁. The first hinge or pivot point 60 can allow the first rotating leg 34, the second rotating leg 36, the connecting member 44, the first inner member 46 and the second inner member 48 to articulate about and between the first longitudinal axis A₁ and a third longitudinal axis A₃ that is substantially perpendicular to the first longitudinal axis A₁. That is, the articulating hanging portion 16 of the shackle 10 can articulate about and between a first shackle position, in which the articulating hanging portion 16 extends along the first longitudinal axis A₁ (as shown in FIG. 1), and a second shackle position. in which the articulating hanging portion 16 extends along the third longitudinal axis A₃ (as shown in FIG. 2). Optionally, it is contemplated that the first rotating leg 34, the second rotating leg 36, the connecting member 44, the first inner member 46 and the second inner member 48 can articulate beyond the third longitudinal axis A₃ and back towards the first longitudinal axis A₁, at a first angle 62. As can be appreciated, the first pivot point 60 can be configured so that the first angle 62 can be any angle between about 1 degree and 359 degrees.

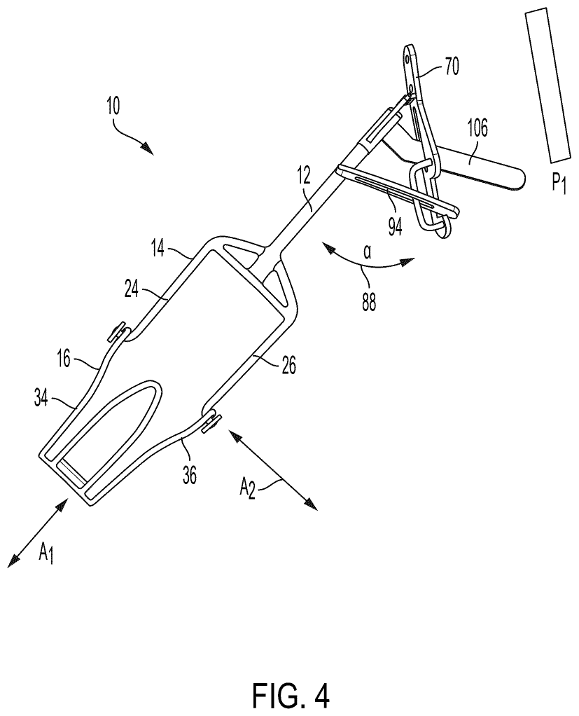

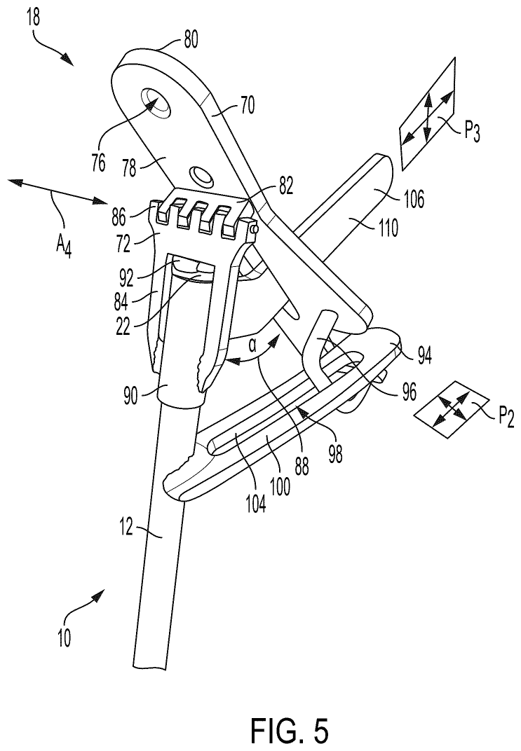

The mounting assembly 18 is shown in more detail in FIGS. 5-7. The mounting assembly 18 can comprise a mounting plate 70 and an attachment element 72. As will be described more fully below, interaction between the mounting plate 70 and the attachment element 72 can urge the central member 12 to rotate such that the central member 12, the first fixed leg 24 and the second fixed leg 26 move about and between the first shackle position as shown in FIG. 1, and a third shackle position as shown in FIG. 4.

The mounting plate 70 can be a substantially flat plate configured for secured attachment to a picking line (not shown) which conveys the shackle 10 around the processing facility. For example, a plurality of bolt or screw holes 76 can be defined from a first face 78 through the mounting plate 70 and to a second face 80 so that the mounting plate 70 can be fixedly attached to a portion of the picking line. Other means of attaching the mounting plate 70 to the picking line, such as welding, are also contemplated. The mounting plate 70 can have a mounting face 75 positioned in a mounting plane P₁.

The attachment element 72 comprises a first attachment element 82 configured to be securedly attached to the mounting plate 70, and an opposed second attachment element 84 configured to be securedly attached to the central member 12. In one aspect, the second attachment element 84 can be rotatably coupled to the first attachment element 82. For example, a second hinge or second pivot point 86 can be formed and/or positioned on the first attachment element 82. In this aspect, the second hinge 86 can be configured so that the central member 12 and the components fixedly attached to the central member 12 such as the first rotating leg 34, the second rotating leg 36, the connecting member 44, the first inner member 46 and the second inner member 48 can rotate about a fourth pivot axis A₄.

The second hinge or pivot point 86 can allow the central member 12, the first rotating leg 34, the second rotating leg 36, the connecting member 44, the first inner member 46 and the second inner member 48 to rotate about and between the first shackle position in which the first longitudinal axis A₁ is substantially parallel to the mounting plane P₁ (as illustrated in FIG. 1), and the third shackle position in which the first longitudinal axis A₁ is at a second angle 88 relative to the mounting plane P₁ (as illustrated in FIG. 4). As can be appreciated, the second hinge 86 can be configured so that the second angle 88 can be any angle between about 0 degrees and 359 degrees.

In one aspect, the attachment element 72 can further comprises a tubular sleeve 90 fixedly attached to a portion of the second attachment element 84. In this aspect, the tubular sleeve 90 can have an inner diameter configured so that at least a portion of the second end 22 of the central member 12 can extend through the tubular sleeve 90. An end tip 92 positioned on the portion of the second end 22 of the central member 12 that extends through the tubular sleeve 90 can have an end tip diameter greater than the inner diameter of the tubular sleeve 90, so that once the end tip 92 is inserted through the tubular sleeve 90, the central member 12 cannot be removed from the tubular sleeve 90. In another aspect, the portion of the second end 22 of the central member 12 that is positioned within the tubular sleeve 90 can have an outer diameter less than the inner diameter of the tubular sleeve 90, so that the second end 22 of the central member 12 can rotate relative to the tubular sleeve 90 about the first longitudinal axis A₁. That is, the central member 12 and the components fixedly attached to the central member 12 such as the fixed hanging portion 14 and the articulating hanging portion 16 of the shackle 10 can rotate about the first longitudinal axis A₁.

The mounting assembly 18 can further comprise a guide plate 94 fixedly attached to a portion of the central member 12, and a guide pin 96 fixedly attached to the mounting plate 70. An arcuate guide slot 98 can be defined in a portion of the guide plate 92, the guide pin 96 being configured to interact with the guide slot 98 for urging the central member 12 in a desired direction and/or orientation.

The guide plate 94 can be a rigid plate fixedly attached to a portion of the second end 22 of the central member 12. The guide plate 94 can have a substantially planer guide face 100 positioned in a guiding plane P₂. As illustrated in FIG. 2, the guide face 100 can be at a third angle 102 relative to the first longitudinal axis A₁. As can be appreciated, the guide face 100 can be configured so that the third angle 102 can be any angle between about 0 degrees and 359 degrees.

With reference again to FIG. 5, the arcuate guide slot 98 can be defined in the guide plate 94, the arcuate guide slot 98 having a predetermined slot length and slot width. In one aspect, the slot width can remain constant along the length of the guide slot 98. Optionally, the slot width can vary along the length of the guide slot 98. In one aspect, the guide slot 98 can have slot walls 104 that are substantially perpendicular to the guide face 100. Optionally, the slot walls 104 can be at an acute angle relative to the guide face 100 so that the slot walls 104 taper away or towards the guide face 100.

The guide pin 96 coupled to the mounting plate 70 can be configured to fit in the guide slot 98. That is, the guide pin 96 can have a pin width that is less than the slot width. Interaction between the guide pin 96 and the slot wall 104 of the guide slot 98 can cause the central member 12 to rotate in a predetermined direction about the fourth pivot axis A₄, and/or interaction between the guide pin 96 and the slot wall 104 of the guide slot 98 can cause the central member 12 to rotate about the first longitudinal axis A₁.

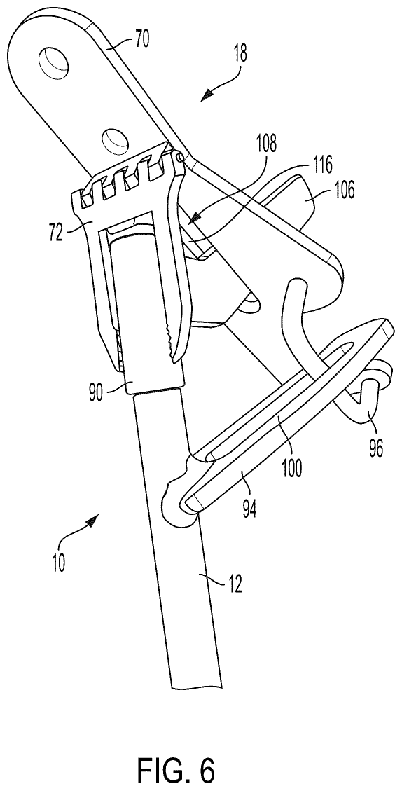

In one aspect, the mounting assembly 18 can further comprise a pushing arm 106 securedly coupled to a portion of the tubular sleeve 90, and a pushing arm aperture 108 defined therethrough the mounting plate 70, as shown in FIG. 6. The pushing arm aperture 108 can be defined in the mounting plate 70 such that the pushing arm aperture 108 has a predetermined aperture length and aperture width. In one aspect, the aperture slot width can remain constant along the length of the pushing arm aperture 108. Optionally, the aperture width can vary along the length of the pushing arm aperture 108. In one aspect, the pushing arm aperture 108 can have aperture walls 116 that are substantially perpendicular to the pushing arm face 110. Optionally, the aperture walls 116 can be at an acute angle relative to the pushing arm face 110 so that the aperture walls 116 taper away or towards the pushing arm face 110.

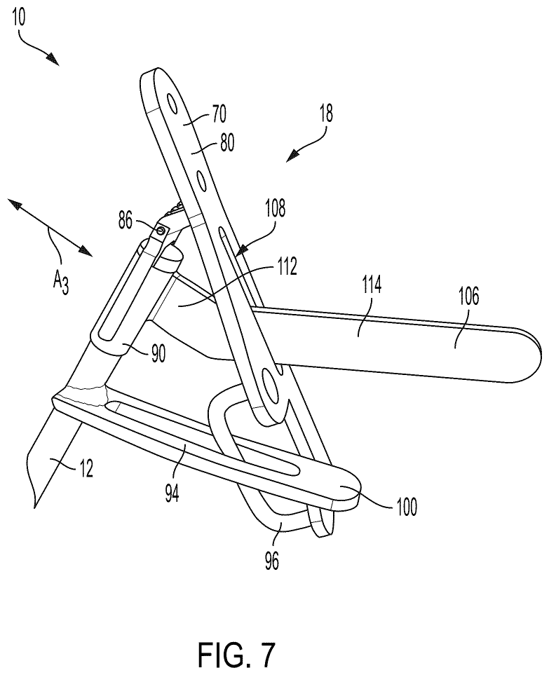

The pushing arm 106 can be a rigid plate fixedly attached to a portion of the tubular sleeve 90. The pushing arm 106 can have a substantially planar pushing arm face 110 positioned in a pushing arm plane P₃, as shown in FIG. 5. In one aspect, the pushing arm 106 can be fixedly attached to the tubular sleeve 90 such that the pushing arm plane P₃ is substantially perpendicular to the guide face plane P₂. Optionally, the pushing arm plane P₃ can be at an acute angle relative to the guide face plane P₂. In another aspect, the pushing arm 106 can be an elongate arm extending linearly away from the tubular sleeve 90 in a straight direction. Alternatively, however, the pushing arm 106 can have a first arm portion 112 extending along a fifth longitudinal axis A₅ that is substantially parallel to the third longitudinal axis A₃, and a second arm portion 114 extending away from the firth longitudinal axis A₅ at an acute angle, as shown in FIG. 7. Optionally, at least a portion of the pushing arm 106 can be arcuate in shape.

The pushing arm 106 coupled to the tubular sleeve 90 can be configured to slide through the pushing arm aperture 108 defined in the mounting plate 70. That is, the pushing arm 106 can have an arm width that is less than the aperture width. As will be described more fully below, translational movement of the pushing arm 106 through the pushing arm aperture 108 can cause the tubular member 90 to urge the central member 12 in a predetermined direction.

The assembled shackle 10 can have one, two, three or more than three rotational degrees of freedom. For example, the rotational degrees of freedom can comprise at least one of: 1) the first rotating leg 34, the second rotating leg 36, the connecting member 44, the first inner member 46 and the second inner member 48 can rotate relative to the first fixed leg 24 and the second fixed leg 26 about the second pivot axis A₂; 2) the central member 12, the first rotating leg 34, the second rotating leg 36, the connecting member 44, the first inner member 46, the second inner member 48, the first fixed leg 24, the second fixed leg 26 and the guide plate 92 can rotate relative to the tubular sleeve 90 about the first longitudinal axis A₁; 3) the central member 12, the first rotating leg 34, the second rotating leg 36, the connecting member 44, the first inner member 46, the second inner member 48, the first fixed leg 24, the second fixed leg 26, the guide plate, 92, the tubular sleeve 90, the pushing arm 106 and the second attachment element 84 can rotate relative to the first attachment element 82 about the fourth pivot axis A₄.

In the first shackle position, as shown in FIG. 1, the first longitudinal axis A₁ and the second pivot axis A₂ can both be substantially parallel to the mounting plane P₁ of the mounting face 75. That is, in the first shackle position, gravity can allow the central member 12 to hang such that the central member, the first fixed leg 24, and the second fixed leg 26 extend substantially linearly in a plane substantially parallel to the mounting face 75. In the first shackle position, the second angle 88 formed between the longitudinal axis A₁ and the mounting plane P₁ can be about 0 degrees.

In the third shackle position, as shown in FIG. 4, the first longitudinal axis A₁ can be at an angle greater than 0 degrees relative to the mounting plane P₁ of the mounting face 75, and the second pivot axis A₂ can be rotated about 90 degrees relative to the mounting plane P₁ of the mounting face 75. That is, in the third shackle position, the central member 12, the first fixed leg 24, and the second fixed leg 26 can be rotated away from the mounting face 75 (by the second angle 88), while simultaneously, the central member 12, the first fixed leg 24, and the second fixed leg 26 can be rotated about the first longitudinal axis A₁ such that the second pivot axis A₂ is also rotated 90 degrees relative to its position in the first shackle position. As such, in the third shackle position, the central cavity 58 defined by the first fixed leg 24, the second fixed leg 26, the first rotating leg 34, the second rotating leg 36 and the connecting member 44 has also rotated 90 degrees.

For example, in the first shackle position, a bird could be positioned in the central cavity 58 by inserting the legs of the bird through the central cavity 58 in a direction moving towards the mounting plate 70, while in the third shackle position, a bird could be positioned in the central cavity 58 by inserting the legs of the bird through the central cavity 58 in a direction moving sideways relative to the mounting plate 70,

In use, as the shackle 10 moves through the processing facility on a conveyor picking line, portions of the processing facility can be sized and shaped to interact with the shackle. For example and without limitation, a bar, a frame and the like can be positioned to engage the pushing arm 106 as the shackle 10 is conveyed from a first location towards a second location. This engagement of the pushing arm 106 with a bar or frame can cause the pushing arm 106 to urge the shackle from first shackle position to the third shackle position. Similarly, the same or a different bar or frame can engage the articulating hanging portion 16 of the shackle 10 as the shackle 10 is conveyed from a first location towards a second location. This engagement of the articulating hanging portion 16 with a bar or frame can cause the shackle to move from the first shackle position to the second shackle position. As can be appreciated, the articulating hanging portion 16 of the shackle 10 can be move about and between the first shackle position and the second shackle position when the pushing arm 106 is in the first shackle position and when the pushing arm 106 is in the third shackle position. That is, the articulating hanging portion 16 can be rotated about the second pivot axis A₂ regardless of the rotational status of any other components of the shackle 10.

As can also be appreciated, in the processing facility, a bird can be positioned so that the feet of the bird are extended. As the shackle 10 approaches the bird, a bar or frame of the processing facility can urge the shackle 10 from the first shackle position to the third shackle position for picking the bird. That is, the shackle 10 can be rotated about 90 degrees so that the feet of the bird can be caught from the side. After catching the bird, the shackle 10 can be conveyed away from the bar or frame so that gravity urges the shackle 10 from the third shackle position back to the first shackle position for conventional conveyance of the bird throughout the facility.

Further, it is contemplated that the shackle 10 need not have all the components described herein. For example, the shackle 10 can be an articulating shackle only, in which the first hinge or first pivot point 60 can be formed and/or positioned on the distal end 32 of the first fixed leg 24 and/or the second fixed leg 26 so that the first rotating leg 34, the second rotating leg 36, the connecting member 44, the first inner member 46 and the second inner member 48 can rotate about the second pivot axis A₂ but without the rotating mounting assembly 18. That is, the shackle 10 can be similar to a conventional shackle 10 with the addition of the first hinge 60 to make the shackle 10 an articulating shackle. In another example, the shackle 10 can be a rotating shackle only, in which the central member 12, the first rotating leg 34, the second rotating leg 36, the connecting member 44, the first inner member 46, the second inner member 48, the first fixed leg 24, the second fixed leg 26 and the guide plate 92 can rotate relative to the tubular sleeve 90 about the first longitudinal axis A₁ without the first hinge 60. That is, the shackle 10 can be similar to a conventional shackle with the addition of the mounting assembly 18 to make the shackle a rotating shackle.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

What is claimed is:

1. A shackle for hanging live poultry on a picking line of a processing facility, the shackle comprising:
a central member coupled to the picking line, the central member being an elongate central member extending along a first longitudinal axis;
a fixed hanging portion coupled to the central member; and
an articulating hanging portion rotatably coupled to the fixed hanging portion, wherein the articulating hanging portion is rotatable relative to the fixed hanging portion about a second pivot axis that is substantially perpendicular to the first longitudinal axis.

2. The shackle of claim 1, wherein the articulating hanging portion of the shackle is rotatable about the second pivot axis about and between a first shackle position, in which the articulating hanging portion extends along the first longitudinal axis, and a second shackle position, in which the articulating hanging portion 16 extends along the third longitudinal axis.

3. The shackle of claim 2, wherein the central member is rotatably coupled to the picking line by a mounting assembly comprising:
a mounting plate fixedly attached to the picking line; and
an attachment element comprising a first attachment element fixedly coupled to the central member, and a second attachment element coupled to the central member and rotatably coupled to the first attachment element such that the central member and the fixed hanging portion of the shackle can rotate about a fourth pivot axis that is parallel to the second pivot axis when the articulating hanging portion of the shackle is in the first shackle position.

4. The shackle of claim 3, wherein the mounting plate has a mounting face positioned in a mounting plane, wherein in the first shackle position, the first longitudinal axis is parallel to the mounting plane.

5. The shackle of claim 4, wherein the articulating hanging portion of the shackle is rotatable about the fourth pivot axis and between the first shackle position, and a third shackle position in which the first longitudinal axis is at an acute angle relative to the mounting plane.

6. The shackle of claim 5, wherein the attachment element further comprises a tubular sleeve fixedly coupled to the second attachment element, wherein a second end of the central member extends through the tubular sleeve, and wherein the central member is rotatable relative to the tubular sleeve about the first longitudinal axis.

7. The shackle of claim 6, wherein the articulating hanging portion of the shackle has at least three degrees of rotational freedom.

8. The shackle of claim 7, wherein a first degree of rotational freedom of the articulating hanging portion is rotation of the articulating hanging portion relative to the fixed hanging portion about the second pivot axis, wherein a second degree of rotational freedom of the articulating hanging portion is rotation of the articulating hanging portion relative to the mounting plane about the fourth pivot axis, and wherein a third degree of rotational freedom of the articulating hanging portion is rotation of the articulating hanging portion relative to the tubular sleeve about the first longitudinal axis.

9. The shackle of claim 8, wherein the mounting assembly further comprises:
a guide plate fixedly attached to a portion of the central member, wherein an arcuate guide slot is defined in the guide plate; and
a guide pin fixedly attached to the mounting plate, wherein the guide pin interacts with the guide slot to urge the central member in a desired direction.

10. A method for hanging live poultry on a picking line of a processing facility, the method comprising:
providing a shackle, the shackle comprising:
a central member coupled to the picking line, the central member being an elongate central member extending along a first longitudinal axis;
a fixed hanging portion coupled to the central member; and
an articulating hanging portion rotatably coupled to the fixed hanging portion, wherein the articulating hanging portion is rotatable relative to the fixed hanging portion about a second pivot axis that is substantially perpendicular to the first longitudinal axis; and
inserting legs of the poultry into slots defined in the articulating hanging portion of the shackle.

11. The method of claim 10, wherein the articulating hanging portion of the shackle is rotatable about the second pivot axis about and between a first shackle position, in which the articulating hanging portion extends along the first longitudinal axis, and a second shackle position, in which the articulating hanging portion 16 extends along the third longitudinal axis.

12. The method of claim 11, wherein the central member is rotatably coupled to the picking line by a mounting assembly comprising:
a mounting plate fixedly attached to the picking line; and
an attachment element comprising a first attachment element fixedly coupled to the central member, and a second attachment element coupled to the central member and rotatably coupled to the first attachment element such that the central member and the fixed hanging portion of the shackle can rotate about a fourth pivot axis that is parallel to the second pivot axis when the articulating hanging portion of the shackle is in the first shackle position.

13. The method of claim 12, wherein the mounting plate has a mounting face positioned in a mounting plane, wherein in the first shackle position, the first longitudinal axis is parallel to the mounting plane.

14. The method of claim 13, wherein the articulating hanging portion of the shackle is rotatable about the fourth pivot axis and between the first shackle position, and a third shackle position in which the first longitudinal axis is at an acute angle relative to the mounting plane.

15. The method of claim 14, wherein the attachment element further comprises a tubular sleeve fixedly coupled to the second attachment element, wherein a second end of the central member extends through the tubular sleeve, and wherein the central member is rotatable relative to the tubular sleeve about the first longitudinal axis.

16. The method of claim 15, wherein the articulating hanging portion of the shackle has at least three degrees of rotational freedom.

17. The method of claim 16, wherein a first degree of rotational freedom of the articulating hanging portion is rotation of the articulating hanging portion relative to the fixed hanging portion about the second pivot axis, wherein a second degree of rotational freedom of the articulating hanging portion is rotation of the articulating hanging portion relative to the mounting plane about the fourth pivot axis, and wherein a third degree of rotational freedom of the articulating hanging portion is rotation of the articulating hanging portion relative to the tubular sleeve about the first longitudinal axis.

18. The method of claim 17, wherein the mounting assembly further comprises:
a guide plate fixedly attached to a portion of the central member, wherein an arcuate guide slot is defined in the guide plate; and
a guide pin fixedly attached to the mounting plate, wherein the guide pin interacts with the guide slot to urge the central member in a desired direction.

19. A system for moving poultry through a processing facility, the system comprising:
at least one shackle coupled to a picking line, the shackle comprising:
a central member coupled to the picking line, the central member being an elongate central member extending along a first longitudinal axis;
a fixed hanging portion coupled to the central member; and
an articulating hanging portion rotatably coupled to the fixed hanging portion, wherein the articulating hanging portion is rotatable relative to the fixed hanging portion about a second pivot axis that is substantially perpendicular to the first longitudinal axis; and
the picking line that conveys the at least one shackle through the processing facility.

20. The system of claim 19, wherein the articulating hanging portion of the shackle is rotatable about the second pivot axis about and between a first shackle position, in which the articulating hanging portion extends along the first longitudinal axis, and a second shackle position, in which the articulating hanging portion 16 extends along the third longitudinal axis.
